(19) United States
(12) Patent Application Publication
(10) Pub. No.: US 2005/0190302 A1
(43) Pub. Date: Sep. 1, 2005

(54) Automation of field service color temperature alignment

(76) Inventors: Kirby Ryan Goedde, Morristown, IN (US); Michael Patrick Begala, Carmel, IN (US)

Correspondence Address: THOMSON LICENSING INC., PATENT OPERATIONS, PO BOX 5312, PRINCETON, NJ, 08543-5312, US

(21) Appl. No.: 11/068,271

(22) Filed: Feb. 28, 2005

Related U.S. Application Data
(60) Provisional application No. 60/547,907, filed on Feb. 26, 2004.

(51) Int. Cl. H04N 5/21

(52) U.S. Cl. 348/630

(57) ABSTRACT

A method of adjusting the color alignment of a television is described. In the method, a color scope and a microprocessor are interfaced to a non-volatile memory of a television. Eight color alignment parameters including red bias, red drive, blue bias, blue drive, green bias green drive, brightness and contrast are adjusted using the microprocessor in conjunction with the color scope. The above method advantageously provides a software handle into the television non-volatile memory values that control the color settings to provide an automatic color temperature alignment.

### CROSS-REFERENCE TO RELATED APPLICATIONS

This application claims the benefit of U.S. Provisional Patent Application Ser. No. 60/547,907, entitled “Chipper Chuck Automation of Field Service Color Temperature Alignment” and filed Feb. 26, 2004, which is incorporated by reference herein in its entirety.

### FIELD OF THE INVENTION

The invention relates to a method for assisting service technicians when aligning a television by performing an automatic color temperature alignment.

### BACKGROUND OF THE INVENTION

The term “color temperature” refers to the degree of “whiteness” of white-colored areas of a picture displayed on a television display screen, relative to a given standard. The manual alignment of color temperature by a service person at a television owner's house is a tedious and time-consuming process. Currently, the service person manually adjusts the color temperature parameters stored in a non-volatile memory, such as an EEPROM using test equipment called, Chipper Check and a color scope. The procedure includes the following steps:
1. A color scope is attached to the television monitor,
2. Test equipment called, Chipper Check, is connected to the television monitor and color temperature alignments are performed,
3. The service person manually adjusts red (R), green (G), blue (B) drive, red (R), green (G), blue (B) bias, contrast and brightness while watching the color scope readout.
   When all eight parameters are set correctly, the color scope will then display the desired results.

However, the manual adjustment of the color temperature parameters is a difficult procedure, which requires the television manufacturer as well as the scope manufacturers to provide seminars to teach the service people.

### SUMMARY OF THE INVENTION

The present invention is directed to a method of adjusting the color alignment of a television. In the method, a color scope and a microprocessor are interfaced to a non-volatile memory of a television. Eight color alignment parameters including red bias, red drive, blue bias, blue drive, green bias green drive, brightness and contrast are adjusted using the microprocessor in conjunction with the color scope.

First, adjustment of the red bias is controlled using the microprocessor in conjunction with the color scope. Second adjustment of red drive is controlled using the microprocessor in conjunction with the color scope. Third adjustment of blue bias is controlled using the microprocessor in conjunction with the color scope. Fourth adjustment of blue drive is controlled using the microprocessor in conjunction with the color scope. Fifth adjustment of green bias is controlled using the microprocessor in conjunction with the color scope. Sixth adjustment of green drive is controlled using the microprocessor in conjunction with the color scope. Seventh adjustment of brightness is controlled using the microprocessor in conjunction with the color scope. Eighth adjustment of contrast is controlled using the microprocessor in conjunction with the color scope.

The above method advantageously provides a software handle into the television non-volatile memory values that control the color settings to provide an automatic color temperature alignment.

### BRIEF DESCRIPTION OF THE DRAWINGS

The invention is hereinafter described in detail with reference to the accompanying drawings, in which:

FIG. 1 is a schematic drawing of a television having a color scope and microprocessor attached thereto; and

FIG. 2 depicts a flow chart of an embodiment of the present invention in which eight color alignment parameters of the television including red bias, red drive, blue bias, blue drive, green bias green drive, brightness and contrast are adjusted using the microprocessor in conjunction with the color scope.

### DETAILED DESCRIPTION

The present invention relates to the field of diagnosing, troubleshooting, initializing and updating television devices in the field by a service person. Thomson Inc., Indianapolis, Ind. uses test equipment, called Chipper Check, which can be implemented in a microprocessor, for retrieving and updating the information stored on a nonvolatile memory, such as an EEPROM, of a television. The present invention implements a user interface through Chipper Check that provides color scope manufacturers a software handle into the television EEPROM values that control the color temperature settings to provide an automatic color temperature alignment.

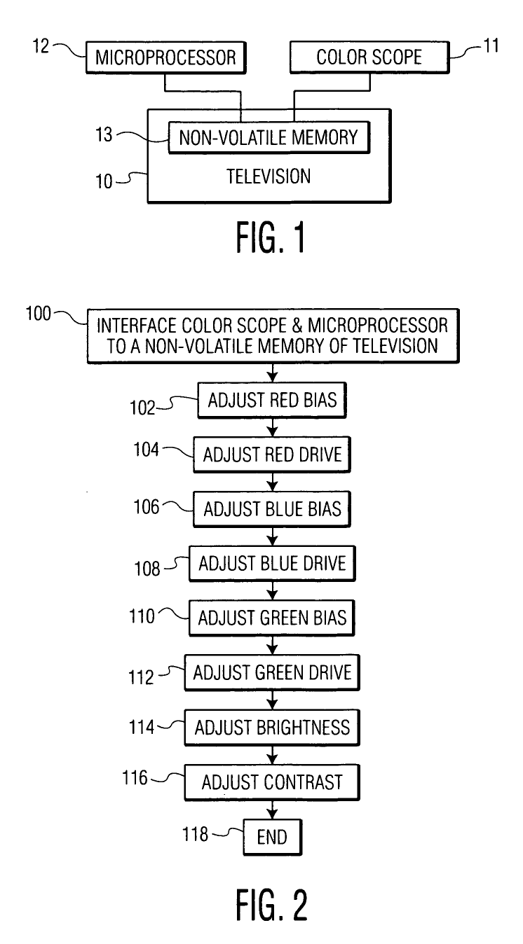

Referring to FIG. 1, a color scope 11 and a microprocessor 12 are interfaced to a non-volatile memory 13 of a television 10. Eight color alignment parameters including red bias, red drive, blue bias, blue drive, green bias green drive, brightness and contrast are adjusted using the microprocessor 12 in conjunction with the color scope 11.

FIG. 2 depicts a flow chart of an embodiment of the present invention. As shown in step 100, a color scope and microprocessor are interfaced to a non-volatile memory of the television. Thereafter, eight color alignment parameters of the television including red bias, red drive, blue bias, blue drive, green bias green drive, brightness and contrast are adjusted using the microprocessor in conjunction with the color scope. First, as shown in step 102, adjustment of the red bias is controlled using the microprocessor in conjunction with the color scope. Second, as shown in step 104, adjustment of red drive is controlled using the microprocessor in conjunction with the color scope. Third, as shown in step 106, adjustment of blue bias is controlled using the microprocessor in conjunction with the color scope. Fourth, as shown in step 108, adjustment of blue drive is controlled using the microprocessor in conjunction with the color scope. Fifth, as shown in step 110, adjustment of green bias is controlled using the microprocessor in conjunction with the color scope. Sixth, as shown in step 112, adjustment of green drive is controlled using the microprocessor in conjunction with the color scope. Seventh, as shown in step 114, adjustment of brightness is controlled using the microprocessor in conjunction with the color scope. Eighth, as shown in step 116 adjustment of contrast is controlled using the microprocessor in conjunction with the color scope. The color temperature alignment is ended with step 118.

In an exemplary embodiment, the automatic color temperature alignment method should include the following steps:

1. Place the color scope on the television monitor.

2. Connect the color scope to a non-volatile memory of television monitor, such as an EEPROM, with Chipper Check and select automatic color temperature alignment, at this point Chipper Check will turn into a TCP/IP server. Chipper Check will create a TCP/IP socket and listen for a connection from the color scope software. This connection may be an internal connection (a connection from a program on the same computer) or an external connection (a connection from a program on a different computer).

3. Start the color scope application software to initialize a connection with Chipper Check. The color scope software initializes a TCP/IP connection with the Chipper Check TCP/IP server over the socket established in step 2.

4. Once the connection is established, the color scope software may use a defined set of Chipper Check instructions including
a) increase red bias
b) decrease red bias
c) increase red drive
d) decrease red drive
e) increase blue bias
f) decrease blue bias
g) increase blue drive
h) decrease blue drive
i) increase green bias
j) decrease green bias
k) increase green drive
l) decrease green drive
m) increase brightness
n) decrease brightness
o) increase contrast
p) decrease contrast
   With the use of these instructions, an automatic color temperature alignment is performed.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A method of adjusting color alignment of a television, comprising:
interfacing a color scope and a microprocessor to a non-volatile memory of a television;
controlling adjustment of red bias using the microprocessor in conjunction with the color scope;
controlling adjustment of red drive using the microprocessor in conjunction with the color scope;
controlling adjustment of blue bias using the microprocessor in conjunction with the color scope;
controlling adjustment of blue drive using the microprocessor in conjunction with the color scope;
controlling adjustment of green bias using the microprocessor in conjunction with the color scope;
controlling adjustment of green drive using the microprocessor in conjunction with the color scope;
controlling adjustment of brightness using the microprocessor in conjunction with the color scope; and
controlling adjustment of contrast using the microprocessor in conjunction with the color scope.

2. The method of claim 1 wherein the non-volatile memory is an EEPROM.
